(19) United States
(12) Patent Application Publication
(10) Pub. No.: US 2015/0337937 A1
(43) Pub. Date: Nov. 26, 2015

(54) TORQUE VECTORING HYBRID TRANSAXLE

(71) Applicant: GM GLOBAL TECHNOLOGY OPERATIONS LLC, Detroit, MI (US)

(72) Inventor: Rolando V. Rodriguez, Metamora, MI (US)

(73) Assignee: GM GLOBAL TECHNOLOGY OPERATIONS LLC, Detroit, MI (US)

(21) Appl. No.: 14/285,883

(22) Filed: May 23, 2014

(51) Int. Cl. F16H 48/36; F16H 3/72; F16H 48/10

(52) U.S. Cl. CPC F16H 48/36; F16H 48/10; F16H 3/72; F16H 2048/364

(57) ABSTRACT

A transaxle for a vehicle includes an input driven shaft that extends along a drive axis, between a first end and a second end. The input driven shaft is rotatable about the drive axis. A first planetary gear train is coupled to the first end of the input driven shaft, and a first motor is coupled to the first planetary gear train. A second planetary gear train is coupled to the second end of the input driven shaft, and a second motor is coupled to the second planetary gear train. The first motor and the second motor provide torque to the first planetary gear train and the second planetary gear train independently of each other to provide a differential functionality and allow torque vectoring between drive wheels.

### TECHNICAL FIELD

The invention generally relates to a transaxle for a vehicle.

### BACKGROUND

A transmission of a vehicle transfers motive force or power from a primary power source, e.g., an engine, to the drive wheels of the vehicle. The transmission typically includes a gear set that allows the engine to cycle through its torque range a number of times to change the torque applied to and the rotational speed of the drive wheels. A differential of a vehicle splits the torque from the primary power source, between a pair of drive wheels, thereby allowing each drive wheel to rotate at different rotational speeds. A transaxle combines the functionality of the transmission and the differential, along with all of the associated components of a driven axle, into a single integrated assembly.

Vehicles may further include a vehicle stability control system and/or a limited slip differential system to control wheel speed and torque distribution. Vehicle stability control systems and limited slip differentials typically use friction elements, such as brakes and/or clutches, to reduce wheel speed. Friction from the friction elements waste energy as heat, and wears the components of the friction elements.

### SUMMARY

A transaxle for a vehicle is provided. The transaxle includes an input driven shaft that extends along a drive axis, between a first end and a second end. The input driven shaft is rotatable about the drive axis. A first planetary gear train is coupled to the first end of the input driven shaft, and a first motor is coupled to the first planetary gear train. A second planetary gear train is coupled to the second end of the input driven shaft, and a second motor is coupled to the second planetary gear train.

A powertrain for a vehicle is also provided. The powertrain includes a primary power source that is operable to generate a drive torque. A transaxle is coupled to the primary power source, and is operable to receive the drive torque from the primary power source. The transaxle includes an input driven shaft that extends along a drive axis, between a first end and a second end. The input drive shaft is rotatable about the drive axis in response to the drive torque from the primary power source. A first planetary gear train is coupled to the first end of the input driven shaft. The first planetary gear train includes a first sun gear, a plurality of first planetary gears, and a first ring gear. The first sun gear is attached to and rotatable with the input driven shaft. The plurality of first planetary gears is supported by a first carrier. A first driven wheel is coupled to the first carrier of the first planetary gear train. A first motor is coupled to the first ring gear. The first motor is operable to supply torque to the first ring gear. A second planetary gear train is coupled to the second end of the input driven shaft. The second planetary gear train includes a second sun gear, a plurality of second planetary gears, and a second ring gear. The second sun gear is attached to and rotatable with the input driven shaft. The plurality of second planetary gears is supported by a second carrier. A second driven wheel is coupled to the second carrier of the second planetary gear train. A second motor is coupled to the second ring gear. The second motor is operable to supply torque to the second ring gear. The first motor and the second motor are independently operable to provide different torque inputs to the first planetary gear train and the second planetary gear train respectively, to change a gear ratio and to change side-to-side speed and torque outputs of the first planetary gear train and the second planetary gear train respectively.

Accordingly, the transaxle uses torque from the first motor and the second motor to continuously vary the individual wheel speed and torque to the first driven wheel and the second driven wheel respectively. The gear ratio of the first planetary gear train and the second planetary gear train are changed by changing a rotational speed of the first ring gear and the second ring gear respectively, by the torque from the first motor and the second motor respectively. The independent first planetary gear train with the first motor, and second planetary gear train with the second motor, provides differential functionality and torque vectoring for optimum performance, without wasting energy as frictional heat, and without undue wear on components.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a powertrain of a vehicle shown in a longitudinal configuration.

FIG. 2 is a schematic perspective view of the powertrain shown in a transverse configuration.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a powertrain is generally shown at 20. The powertrain 20 is for a vehicle, and includes a primary power source 22 that is operable to generate a drive torque. The primary power source 22 may include, but is not limited to, an internal combustion engine 23, such as a gasoline or diesel engine. Additionally, the primary power source 22 may include one or more electric motors 25 operating independently of the internal combustion engine 23 or in combination with the internal combustion engine 23, to generate the drive torque. The specific orientation and/or configuration of the primary power source 22 is not pertinent to the detailed description, and as such is not described in greater detail herein.

A transaxle 24 is coupled to the primary power source 22. The transaxle 24 is operable to receive the drive torque from the primary power source 22, and transfer the drive torque to a pair of driven wheels, i.e., a first driven wheel 26 and a second driven wheel 28. A clutch or damping device 30 may be disposed between the primary power source 22 and the transaxle 24. However, it should be appreciated that the powertrain need not include the clutch or damping device 30. The clutch or damping device 30 may include, but is not limited to, a dry clutch 30 or other similar device. The clutch 30 is operable to selectively engage and disengage the primary power source 22 and the transaxle 24 to decouple the primary power source 22 from the transaxle 24 when the vehicle is stopped or coasting. Alternatively, the clutch or damping device 30 may include a torsional damper 30. The torsional damper is operable to dampen torsional vibrations through the powertrain 20.

The transaxle 24 includes an input driven shaft 32. The input driven shaft 32 extends along a drive axis 34, between a first end 36 and a second end 38. The input driven shaft 32 is rotatable about the drive axis 34 in response to the drive torque from the primary power source 22.

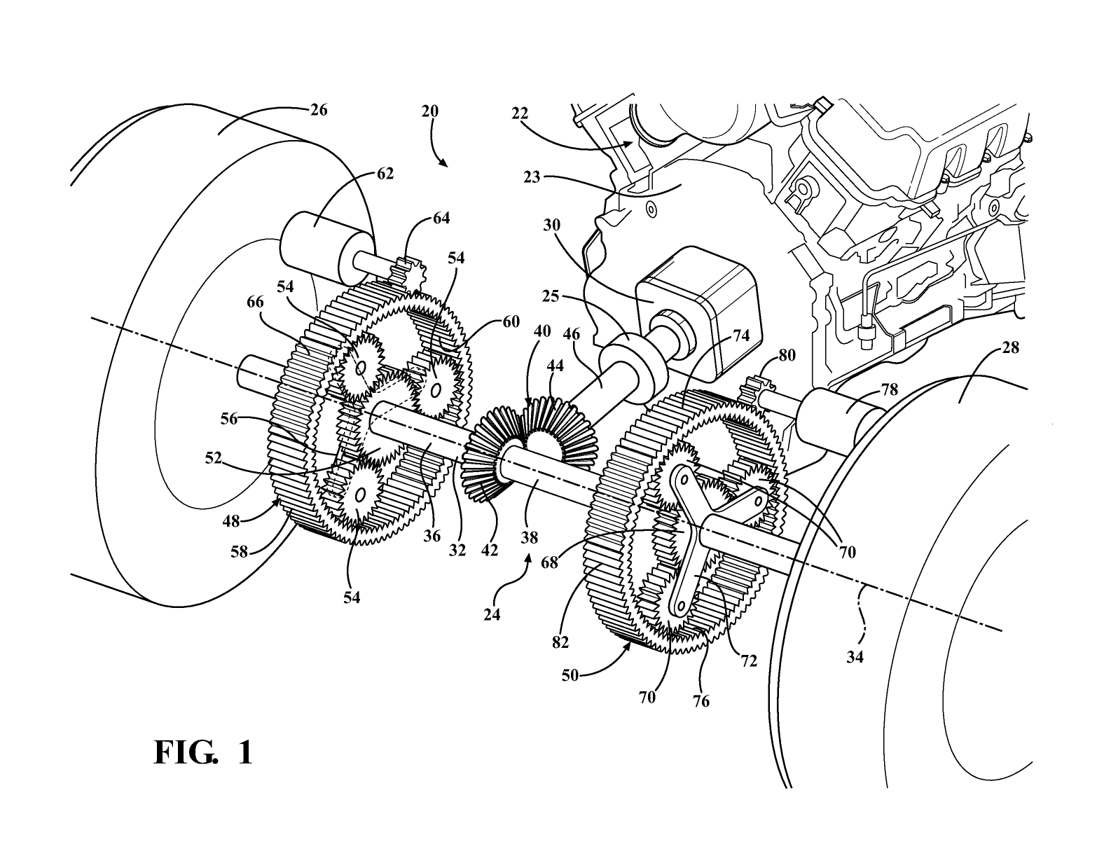

The transaxle 24 may include an input torque transfer system 40 that is coupled to and interconnects the input driven shaft 32 and the primary power source 22. The input torque transfer system 40 is operable to transfer the drive torque from the primary power source 22 to the input driven shaft 32. In vehicles including a longitudinally mounted engine 23, such as the exemplary embodiment shown in FIG. 1, the input torque transfer system 40 may include, for example, a hypoid ring and pinion gear set. The hypoid ring and pinion gear set may include a hypoid ring gear 42 that is attached to and rotatable with the input driven shaft 32, and a hypoid pinion gear 44 that is disposed in meshing engagement with the hypoid ring gear 42. The hypoid pinion gear 44 is attached to and rotatable with a torque output shaft 46. The torque output shaft 46 is coupled to the primary power source 22 via the clutch 30. The hypoid pinion gear 44 transfers the drive torque from the primary power source 22 to the hypoid ring gear 42.

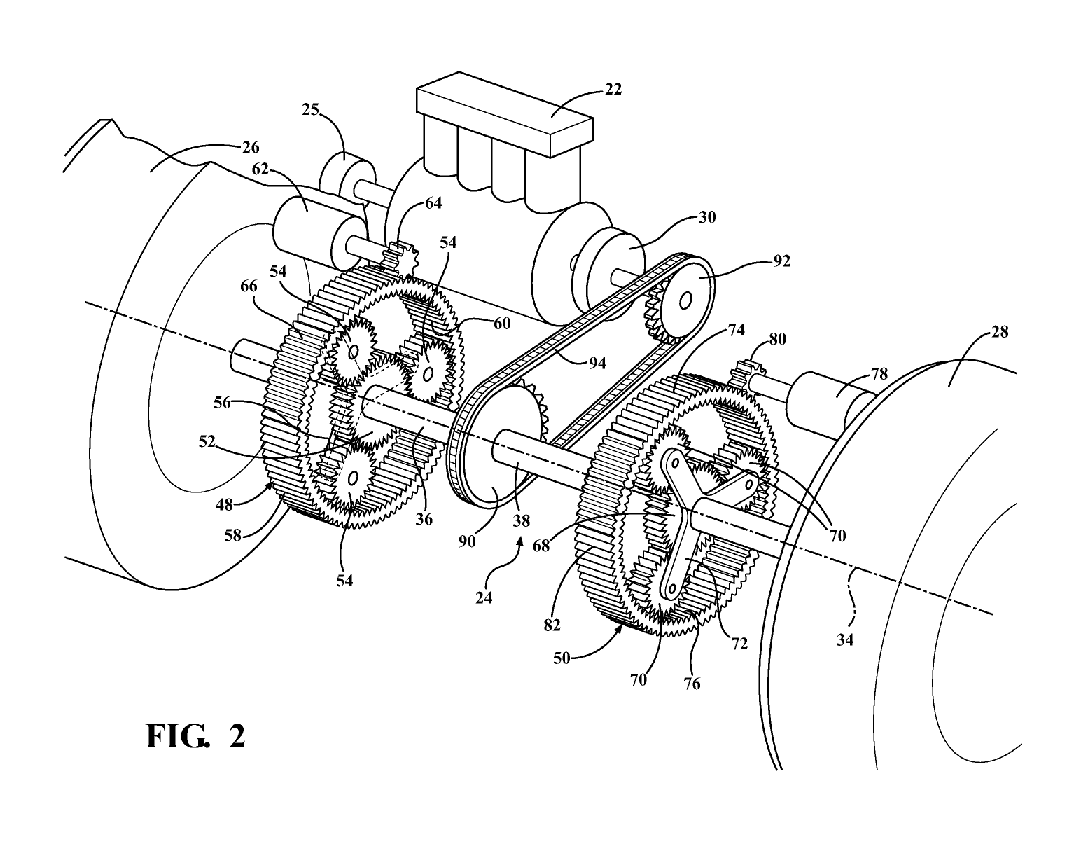

In vehicles including a transversely mounted engine 23, such as the exemplary embodiment shown in FIG. 2, the input torque transfer system 40 may include, for example, a belt or chain driven gear set. The belt or chain driven gear set may include a first chain gear that is attached to and rotatable with the driven shaft 32, and a second chain gear attached to and rotatable with the torque output shaft 46. An endless belt, such as a chain or other similar device, is engaged with both the first chain gear and the second chain gear in an endless loop, to transfer torque from the torque output shaft 46 to the input shaft 32. As noted above, the torque output shaft 46 is coupled to the primary power source 22 via the clutch 30. It should be appreciated that the input torque transfer system 40 may be configured other than described herein and shown in the Figures.

The transaxle 24 includes a first planetary gear train 48 and a second planetary gear train 50. The first planetary gear train 48 is coupled to the first end 36 of the input driven shaft 32. The first planetary gear train 48 includes a first sun gear 52, a plurality of first planetary gears 54 supported by a first carrier 56, and a first ring gear 58. The first sun gear 52 is attached to and rotatable with the input driven shaft 32. The plurality of first planetary gears 54 are disposed annularly about the first sun gear 52, rotate with the first carrier 56 about the driven axis, and are in meshing engagement with an interior circumferential gear surface 60 of the first ring gear 58. The first driven wheel 26 is coupled to and rotates with the first carrier 56 of the first planetary gear train 48.

A first motor 62 is coupled to the first planetary gear train 48. The first motor 62 may include, but is not limited to, an electric motor or a hydraulic motor. The first ring gear 58 is coupled to the first motor 62. The first ring gear 58 is operable to receive torque from the first motor 62. The first motor 62 may be coupled to the first ring gear 58 in any manner capable of transmitting torque and/or adjusting a rotational speed of the first ring gear 58. For example, the first motor 62 may include a first gear 64 that is disposed in meshing engagement with an exterior circumferential gear surface 66 of the first ring gear 58. The first gear 64 is operable to receive torque from the first motor 62, and transfer the torque from the first motor 62 to the first ring gear 58.

The second planetary gear train 50 is coupled to the second end 38 of the input driven shaft 32. The second planetary gear train 50 includes a second sun gear 68, a plurality of second planetary gears 70 supported by a second carrier 72, and a second ring gear 74. The second sun gear 68 is attached to and rotatable with the input driven shaft 32. The plurality of second planetary gears 70 are disposed annularly about the second sun gear 68, rotate with the second carrier 72 about the driven axis, and are in meshing engagement with an interior circumferential gear surface 76 of the second ring gear 74. The second driven wheel 28 is coupled to and rotates with the second carrier 72 of the second planetary gear train 50.

A second motor 78 is coupled to the second planetary gear train 50. The second motor 78 may include, but is not limited to, an electric motor or a hydraulic motor. The second ring gear 74 is coupled to the second motor 78. The second ring gear 74 is operable to receive torque from the second motor 78. The second motor 78 may be coupled to the second ring gear 74 in any manner capable of transmitting torque and/or adjusting a rotational speed of the second ring gear 74. For example, the second motor 78 may include a second gear 80 that is disposed in meshing engagement with an exterior circumferential gear surface 82 of the second ring gear 74. The second gear 80 is operable to receive torque from the second motor 78, and transfer the torque from the second motor 78 to the second ring gear 74.

The first motor 62 and the second motor 78 are independently operable to provide different torque inputs to the first planetary gear train 48 and the second planetary gear train 50 respectively. By using two independent motors, i.e., the first motor 62 and the second motor 78, coupled to the first planetary gear train 48 and the second planetary gear train 50 respectively, a gear ratio and side-to-side speed and torque outputs to the first driven wheel 26 and the second driven wheel 28 may be changed. The gear ratio may be changed by changing a rotational speed of the first ring gear 58 and/or the second ring gear 74, with torque from the first motor 62 and/or the second motor 78 respectively. Additionally, the transaxle 24 is capable of torque vectoring by applying different torque to the first ring gear 58 and the second ring gear 74, from the first motor 62 and the second motor 78 respectively.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A transaxle for a vehicle, the transaxle comprising:
an input driven shaft extending along a drive axis between a first end and a second end, and rotatable about the drive axis;
a first planetary gear train coupled to the first end of the input driven shaft;
a first motor coupled to the first planetary gear train;
a second planetary gear train coupled to the second end of the input driven shaft; and
a second motor coupled to the second planetary gear train.

2. A transaxle as set forth in claim 1 wherein the first planetary gear train includes a first sun gear, a plurality of first planetary gears supported by a first carrier, and a first ring gear.

3. A transaxle as set forth in claim 2 wherein the first sun gear is attached to and rotatable with the input driven shaft.

4. A transaxle as set forth in claim 3 wherein the first ring gear is coupled to the first motor, and operable to receive torque from the first motor.

5. A transaxle as set forth in claim 4 wherein the plurality of first planetary gears are disposed annularly about the first sun gear, rotate with the first carrier about the driven axis, and are in meshing engagement with an interior circumferential gear surface of the first ring gear.

6. A transaxle as set forth in claim 5 wherein the first motor includes a first gear disposed in meshing engagement with an exterior circumferential gear surface of the first ring gear, and operable to receive torque from the first motor and transfer the torque from the first motor to the first ring gear.

7. A transaxle as set forth in claim 1 wherein the second planetary gear train includes a second sun gear, a plurality of second planetary gears supported by a second carrier, and a second ring gear.

8. A transaxle as set forth in claim 7 wherein the second sun gear is attached to and rotatable with the input driven shaft.

9. A transaxle as set forth in claim 8 wherein the second ring gear is coupled to the second motor, and operable to receive torque from the second motor.

10. A transaxle as set forth in claim 9 wherein the plurality of second planetary gears are disposed annularly about the second sun gear, rotate with the second carrier about the driven axis, and are in meshing engagement with an interior circumferential gear surface of the second ring gear.

11. A transaxle as set forth in claim 10 wherein the second motor includes a second gear disposed in meshing engagement with an exterior circumferential gear surface of the second ring gear, and operable to receive torque from the second motor and transfer the torque from the second motor to the second ring gear.

12. A transaxle as set forth in claim 1 wherein the first motor and the second motor are independently operable to provide different torque inputs to the first planetary gear train and the second planetary gear train respectively, to change a gear ratio and to change side-to-side speed and torque outputs of the first planetary gear train and the second planetary gear train respectively.

13. A transaxle as set forth in claim 1 wherein the first motor and the second motor are each electric motors.

14. A transaxle as set forth in claim 1 wherein the first motor and the second motor are each hydraulic motors.

15. A transaxle as set forth in claim 1 further comprising an input torque transfer system coupled to the input driven shaft and operable to transfer torque from a primary power source to the input driven shaft.

16. A transaxle as set forth in claim 15 wherein the input torque transfer system includes a hypoid ring and pinion gear set having a hypoid ring gear attached to and rotatable with the input driven shaft, and a hypoid pinion gear disposed in meshing engagement with the hypoid ring gear for transferring torque to the hypoid ring gear.

17. A powertrain for a vehicle, the powertrain comprising:
a primary power source operable to generate a drive torque;
a transaxle coupled to the primary power source, and operable to receive the drive torque from the primary power source, the transaxle including:
an input driven shaft extending along a drive axis between a first end and a second end, and rotatable about the drive axis in response to the drive torque;
a first planetary gear train coupled to the first end of the input driven shaft, wherein the first planetary gear train includes a first sun gear attached to and rotatable with the input driven shaft, a plurality of first planetary gears supported by a first carrier, and a first ring gear;
a first motor coupled to the first ring gear and operable to supply torque to the first ring gear;
a second planetary gear train coupled to the second end of the input driven shaft, wherein the second planetary gear train includes a second sun gear attached to and rotatable with the input driven shaft, a plurality of second planetary gears supported by a second carrier, and a second ring gear; and
a second motor coupled to the second ring gear and operable to supply torque to the second ring gear;
wherein the first motor and the second motor are independently operable to provide different torque inputs to the first planetary gear train and the second planetary gear train respectively, to change a gear ratio and to change side-to-side speed and torque outputs of the first planetary gear train and the second planetary gear train respectively;
a first driven wheel coupled to the first carrier of the first planetary gear train; and
a second driven wheel coupled to the second carrier of the second planetary gear train.

18. A powertrain as set forth in claim 17 wherein the first motor and the second motor are each either electric motors, or hydraulic motors.

19. A powertrain as set forth in claim 17 wherein the transaxle further includes an input torque transfer system coupled to the input driven shaft, and operable to transfer the drive torque from the primary power source to the input driven shaft.

20. A powertrain as set forth in claim 19 wherein the input torque transfer system includes a hypoid ring and pinion gear set having a hypoid ring gear attached to and rotatable with the input driven shaft, and a hypoid pinion gear attached to an rotatable with an input shaft, and disposed in meshing engagement with the hypoid ring gear for transferring the drive torque to the hypoid ring gear.
